(19) United States
(12) Patent Application Publication
(10) Pub. No.: US 2012/0311614 A1
(43) Pub. Date: Dec. 6, 2012

(54) ARCHITECTURE FOR PERVASIVE SOFTWARE PLATFORM-BASED DISTRIBUTED KNOWLEDGE NETWORK (DKN) AND INTELLIGENT SENSOR NETWORK (ISN)

(75) Inventors: Robert DeAnna, Frisco, TX (US); John Patoskie, Allen, TX (US); Robert W. Peterson, Plano, TX (US); Thomas T. Wheeler, Frisco, TX (US); Qin Ye, Plano, TX (US)

(73) Assignee: RECURSION SOFTWARE, INC., Frisco, TX (US)

(21) Appl. No.: 13/151,671

(22) Filed: Jun. 2, 2011

(51) Int. Cl. G06F 9/46

(52) U.S. Cl. 719/328

(57) ABSTRACT

A device API Abstraction layer is provided that is configured to operate as an interface between one or more applications operating on a device and an operating platform of the device. The device API abstraction layer comprises a universal set of APIs that enables the applications to execute irrespective of the operating system and software platform of the host device.

### CROSS REFERENCE TO RELATED APPLICATIONS

This application is related to the Applicants and/or Assignees co-pending patent applications Attorney Docket Nos. 20080529.2, 20091113.2 and 2009117.1. The entire contents of each of these patent applications is incorporated herein by reference.

### FIELD OF THE INVENTION

This disclosure relates to software platforms and architectures and in particular to platforms and architectures for use in a heterogeneous device environment.

### BACKGROUND OF THE INVENTION

There is an explosion of mobile and embedded devices throughout the consumer, commercial and government arenas. These devices have ever increasing processing power, data gathering power and data storage capacity. Additionally there is a growing need for advanced applications that are centered around the use case of a dynamic collection of people and devices, for some transient period of time, participated in a coordinate process, task, goal involving knowledge sharing. These types of application range from the DoD, DHS, and Commercial and Consumer worlds. The need for a software platform that enables a Distributed Knowledge Network is now very evident.

But there is currently no Distributed Knowledge Network platform to enable intelligent applications that span these heterogeneous networks and devices, underlying operating systems, software languages, and software protocols. This is not only true for simple client-server mobile environments, but also environments that involve peer-2-peer and peer-2-group communication.

There are no solutions that enable end-to-end Distributed Knowledge Networks and Intelligent Sensor Networks. There are platforms for client-server applications, and simple peer-2-peer networks, but there are no intelligent, unified pervasive platforms that allow for intelligent data gathering, synthesis, fusion and distribution over dynamic collections of heterogeneous devices.

Existing software platforms are either not pervasive enough or intelligent enough. By pervasive, it is meant that the platforms that do exist either are limited in the devices/operating systems they support, or the software languages they support, or the distributed protocols they support, or the messaging capabilities they support.

What is required is a system, method and/or architecture that meets these requirements.

### SUMMARY OF THE INVENTION

In one aspect of the disclosure, there is provided a pervasive computing platform comprising a device API Abstraction layer configured to operate as an interface between one or more applications operating on a device and an operating platform of the device, the device API abstraction layer comprising a universal set of APIs.

In one aspect of the disclosure there is provided a method for providing a distributed knowledge network/intelligent sensor network. The method may comprise deploying a pervasive computer platform onto a plurality of devices, the pervasive computer platform comprising a device API abstraction layer comprising a universal set of APIs that enables agent software applications to execute on those devices irrespective of the parameters of the device. One or more agent software applications may be deployed to one or more of the plurality of devices which executes the deployed agent software application.

In one aspect of the disclosure, there is provided a device comprising at least one processor and at least one memory operatively associated with the at least one processor, the at least one memory storing a universal set of APIs that provides a hardware-independent agent software abstraction layer for one or more sensor capabilities of the device.

### BRIEF DESCRIPTION OF THE DRAWINGS

Reference will now be made, by way of example only, to specific embodiments and to the accompanying drawings in which:

FIG. 1 depicts the basic architecture of a Pervasive Platform that supports the creation of applications for distributed knowledge networks and intelligent sensor networks;

FIG. 2 is a more detailed look into the Application Container;

FIG. 3 depicts peer-to-peer communication between two nodes;

FIG. 4 depicts a universal Pub-sub messaging API;

FIG. 5 depicts three heterogeneous nodes communication through publishing-subscribing services;

FIG. 6 depicts a universal white pages API;

FIG. 7 depicts a universal yellow pages API;

FIG. 8 depicts a universal user interface API;

FIG. 9 depicts a universal database API;

FIG. 10 depicts a universal location and personal information manager API;

FIG. 11 depicts a universal rules API;

FIG. 12 depicts a universal agent API; and

FIG. 13 depicts an Agent Communications Framework Architecture.

### DETAILED DESCRIPTION OF THE INVENTION

The embodiments, modules and examples described below are intended to demonstrate the components and capabilities of a single pervasive platform, that is a one-stop-shopping for enterprise, mobile and embedded servers/devices support for capabilities needed to build advanced applications that span networks, devices and enterprises. These applications can be broadly categorized as Distributed Knowledge Networks and Intelligent Sensor Networks.

Normally a developer would have to go through the arduous task of integrating “n” software products and platforms to create such a platform, where “n” is a very significant number and is growing constantly. Currently, there is no single platform that through a set of Universal API's, brings them together in a platform that extends from the sensor to the cloud, and every major device type in-between.

This single pervasive platform enables plug-n-play technologies, be they geared for the enterprise, mobile or embedded space. An intelligent, distributed computing platform that can provide these capabilities, will be the superhighway for software engineers to leverage in creating the next generation of applications.

Software architects and engineers will have the flexibility to freely develop dynamic, intelligent, and decentralized applications in their language of choice, on the devices and servers they need to target, whether the device/node is a mainframe, desktop, PDA, Smartphone, RFID reader, camera, or embedded sensor.

By utilizing such a platform, developers will have at their disposal a choice of wireless networks, distributed protocols, and decentralized and centralized messaging capabilities to leverage in creating the ad-hoc and distributed social, knowledge, and problem-solving networks of tomorrow.

Utilizing rules engines such as RETE-based rules engine integrated within this next generation platform, engineers can create artificial intelligence and cognitive capabilities into Mobile 2.0 software agents residing on all targeted devices and servers. Engineers will be able to produce applications that provide real-time intelligence, situational awareness, and coordination at the edge not found today.

Enterprise software stacks, like software languages, continue to be born, but “old” ones never go away. J2EE and .NET architectures and related languages dominate, but CORBA and Mainframe systems and their associated languages, are still prevalent within many of these same organizations.

A distributed knowledge network (DKN) and Intelligent Sensor Network (ISN) offers new capabilities for more intelligent, more interoperable and more distributed processes for information gathering, data filter/analysis, information dissemination, and collaboration that ultimately results in faster and more efficient decision making in mobile, widely distributed, heterogeneous environments. These environments span many device types and wired and wireless networks.

These DKNs/ISNs may be developed on the proposed software platform, described below, that allows for decentralized, intelligent, mobile, high-performance, transaction-based applications. The proposed pervasive platform will seamlessly interoperate with the hardware and software technologies of today to pave the way for next-generation solutions for commercial, government, and consumer development. The resulting applications will provide quantum leaps in real-time intelligence capabilities and coordination among widely distributed groups, as well as offer greatly increased productivity and cost savings. In this paradigm, data may be gathered on edge devices, rapidly turned into actionable knowledge, and distributed efficiently to ad hoc, possibly dynamically assembled groups of interested participants, devices, and enterprise systems.

Mobile software components (agents) residing on these edge devices may continuously learn from the data they get and interpret. This can cause them to respond differently and possibly assemble and communicate with an ever-changing audience, forming a distributed knowledge-sharing network.

Software agent-based technologies allow for complex or large software processes to be broken down into smaller components that can be mobilized and reused to enable dynamic decision distribution and integration capabilities via an intelligent software abstraction layer. Data can be analyzed at the source or point of input to the network and prioritized and distributed in an automated process to appropriate consumers of the information on the network. The information consumers can potentially be sensors, smartphones, PDAs, MIDs, UMPCs, Laptops, and an extremely wide array of wireless and embedded devices and systems.

The agent-based distributed knowledge network (DKN) and Intelligent Sensor Network (ISN) will provide the key enabling technologies for translating recent advances in automated data acquisition, digital storage, computers and communications into fundamental advances supporting data Filter/Analysis, dynamic process management, dynamic integration and collaboration for advanced enterprise, consumer, and government applications.

Intelligent mobile agent technology, utilizing dynamically loadable and mobile rule-sets, provides the intelligence behind the framework in the design and implementation of a DKN/ISN. Agent-based peer-2-peer peer-2-group and peer-2-enterprise system architecture provides the framework for varied, no-single-point-of failure, interconnection of computer “nodes”. Using agent-based rule-sets to encapsulate logical processes or algorithms, programmable rules or processes can then be delivered to processing nodes that range from large computer servers to mobile phones and wireless sensors.

In order to implement these new applications, including a DKN/ISN, there is required a next-generation pervasive software platform that can operate seamlessly in the complex, widely distributed environment we find today. One aspect of such is software agent technology that will provide the mobility infrastructure for process mobility, code mobility, rule-set mobility and remote communications.

A true pervasive software platform that forms the foundation of a Distributed Knowledge Network will have extensive support for all devices, their operating systems and platforms, networks, distributed protocols, supported software languages and messaging capabilities. By devices and underlying operating systems, it is meant those that power everything from servers to mobile and embedded devices. By software languages it is meant that the pervasive platform will support prominent languages such as Java, .NET, C++ and other appropriate language as well as scripting languages such as JavaScript, ActionScript, PHP and Ruby. By distributed protocols, it is meant that the pervasive software platform can host Distributed Knowledge Networks via, e.g. Binary XML, SOAP, XML-RPC, IIOP and RMI. And by messaging, it is meant device-to-device (a.k.a peer-2-peer), device-to-device-group (a.k.a peer-2-group) or device-2-enterprise (peer-2-enterprise). Additionally this messaging will be via common and prominent standardized messaging protocols, be it IPv4/IPv6 based (TCP/IP, UDP, JMS, MSMQ, DDS) or not (Bluetooth, Zigbee, Near Field Communication).

The Distributed Knowledge Network (DKN) may be built using an intelligent agent platform that runs devices ranging from servers, to laptops, PDAs, smartphones, Mobile Internet Devices, UItra Mobile PCs, and sensors. Specifically, the DKN System provides:
An Intelligent Software Agent platform that runs on the devices mentioned above, forming the foundation of an distributed knowledge network.
A hardware-independent, Intelligent Agent Software abstraction layer for sensors.
A network platform that contains meta-data about the systems, providing a self-describing capability that enables pluggable, non-intrusive communication with heterogeneous software and groups of heterogeneous nodes.
Agents are responsible for integration and distribution of processing and knowledge between different systems.
The Agents for each of these systems would be a combination of the following types of Agents currently used, or planned for use within the DKN:
   Data Gatherer Agents
   Interface Agents
   Filter/Analysis Agents
   DKN Controller Component Agents

A true pervasive, peer-to-peer application will be able to run, in some form, on all devices ranging from smartphones, routers, MIDs, UMPCs, Netbooks, VoIP phones, sensors, and those found in, or coming soon, to automobiles and remote controlled machines, to name a few. To do so, its software platform will run natively on these same devices. Software agents comprising these applications, also need to be able to run in the popular mobile/embedded software stacks, such as Java's Micro Edition, Android, Microsoft's Compact Framework, and OSGI Containers, on a wide range of mobile/embedded operating systems such as iPhone, Blackberry, Windows Mobile, Symbian, BREW, and Embedded Linux versions (Android, LIMO, Maemo, etc.) to name just a few. All of which will facilitate these pervasive services to function within smartphones, routers, MIDs, UMPCs, VoIP Phones, Telepresence, sensors, automobiles, bus stops, smart meters, and other ICT connected participatory nodes.

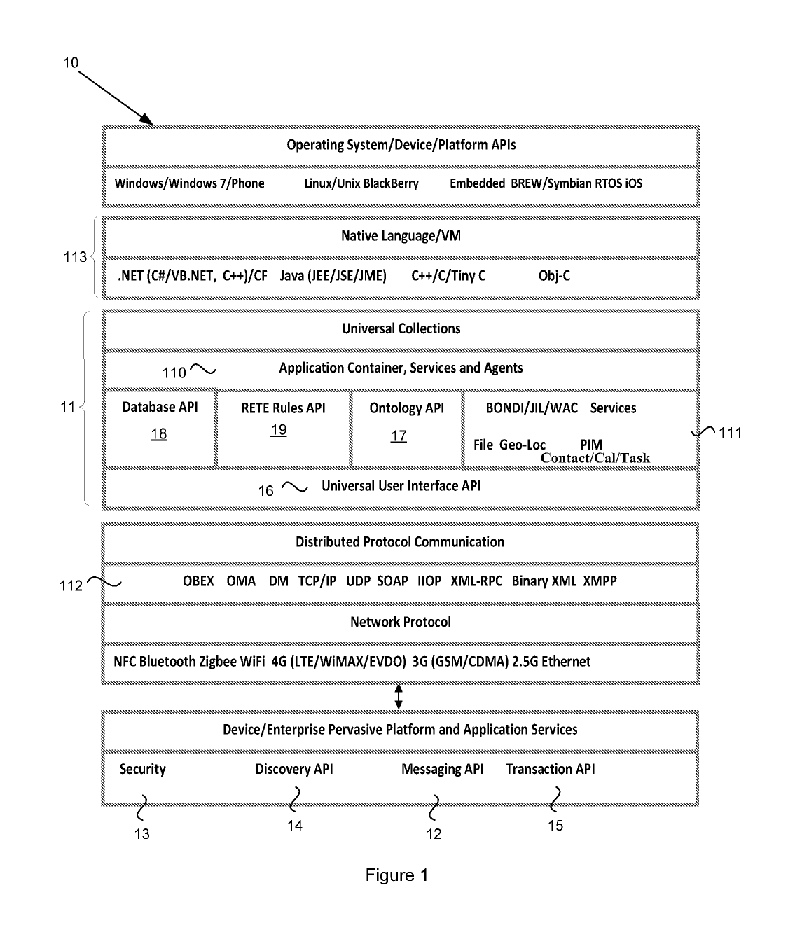

Depicted in FIG. 1 is the proposed software architecture 10 for the nodes that comprise a Distributed Knowledge Network (DKN). It is described in detail in the sections below.

The architecture 10 includes a device API Abstraction layer 11 that provides an abstraction of at least the most common and prominent engines for each relevant capability. Specific APIs include a messaging API 12, security API 13, discovery API 14 (e.g. white pages and yellow pages), transaction API 15, universal user interface API 16, ontology API 17, database API 18, rules API 19 and PIM API 111. The API Abstraction layer operates between a network layer 112, representing the most common type of wired and wireless networks (a.k.a. Networks), and an operating platform layer 113 which represents the most common Operating Systems and software platforms (Operating Systems/Platforms).

A) Dynamic, Decentralized and Centralized Messaging Capability via Messaging API 12

The proposed pervasive platform 10 will enable communication and sharing of application data, between groups of devices/systems without the need of a centralized messaging server. It will support the creation of ad-hoc communities of devices or nodes, as well as the ability to support filtering of application messages across these communities. Support will exist for devices joining and leaving the network, which will result in changing “internet” addresses. Integration with a SIP/IMS Server is one way to provide dynamic IP support along with voice, data, and chat support over IP. The platform will also support passing messages over standard centralized messaging servers for integration with enterprise and legacy systems. More specifically, there needs to be seamless integration with Microsoft's Message Queue (MSMQ), Java's Message Server (JMS) and Object Management Group's (OMG) Data Description Service (DDS), etc.

The messaging capability may be achieved by a Pervasive Software Platform Universal Peer-2-Peer Messaging Sub-Module 12 which is described in further detail below.

B) Network Scalability, Survivability and Discovery Capability via Discovery API 14

The proposed pervasive platform 10 will enable filtering and analyzing of data processing at the source to minimize network traffic, handle unreliable and/or limited network connections, and adjust to hardware failures or CPU load. Therefore, these devices will be able to persist data via a micro relational or objects database. Additionally, the software components or agents running on edge devices need to support multiple wireless protocols (GSM, CDMA, Wi-Fi, UWB, Bluetooth, NFC, RFID, 4G/WiMax/LTE, etc.) and associated networks (Telco, Wide Area, Local, Personal, etc.). Ideally, they will dynamically reconfigure themselves to use a communication protocol that best matches the capabilities of their current network connection and the current node(s) they are in communication with. These capabilities may be provided by Universal Core Request Brokering Sub-Modules such as a Universal Transport Interface, universal Serialization interface and Universal Distributed Protocol/Remote Interface, each of which will be described in more detail below.

C) Mobile SOA Architecture Capability

The proposed pervasive platform will also provide an enhanced Service-Oriented Architecture (SOA) that supports services running on mobile and embedded devices. In other words, any device will be able to host and access services. These services will be accessible in a decentralized fashion directly to agents, exposed as services, that are running on edge and wireless devices. The distributed agents will act more as providers of services and facilitators of exchanges and transactions versus a traditional client/server central provisioning approach. The location of intelligent agents/services and the Mobile Web Services they expose will be irrelevant to the client or target device. Finally, all agents/services need to be accessible by a Service Description in adaptive directories, ideally ones with Universal Description, Discovery, and Integration (UDDI) compliance. Finally, these services will be discoverable over SIP/IMS registries as well, along with network based discovery techniques for advanced abilities to compose and provision services across the layers. These capabilities may be provided by a Universal White Pages and Yellow Pages sub-modules 14, an Intelligent Agent software platform and a Universal Agent sub-module FIG. 13.

D) Configurable, Adaptable Security Framework via Security API 13

In a ubiquitously networked world, it will often be necessary to maintain data on edge devices. The security concerns facing enterprises today will need to incorporate solutions that extend to a collaborative environment. The proposed pervasive software platform will provide a high level of security to ensure privacy and protection from rogue/viral clients and software agents. This will involve security agents and agent managers that provide capabilities above and beyond the current encryption, authentication, and authorization that are currently employed in today's centralized client server applications.

As with every capability within the pervasive platform, the security capability 13 needs to be configurable and pluggable, to allow for adaptable and custom security features specific to the date and/or services being hosted on any particular node. For example, encryption, authentication, and authorization around peer-to-peer and peer-to-group application/event exchanges will all have pluggable security capabilities that tap into the various security services from networks, to clouds, to applications, and so forth.

E) Universal Platform/Services—.NET/Java/C++/JS from Clouds to Sensors

Advanced pervasive applications cannot be limited to a single development environment and programming language. Furthermore, the same API will be provided to .NET, Java, C/C++ and JavaScript developers. The platform will support a common set of collections and algorithms across these languages as well. This would greatly increase programmer productivity and allow developers from all camps to easily work together and share software. The platform will seamlessly integrate with .NET, JEE and legacy (MVS, CORBA, etc.) enterprise systems and services, and any combination thereof, in either a traditional Web Services architecture, or in a high performance manner using binary protocols. Pervasive applications may need to communicate with more than one enterprise/organization or governmental entity.

With the advent of Software-As-A-Service (SAAS) and Infrastructure-As-A-Service (IAAS) based cloud computing, there will be an evolving need for inter-cloud interoperability. This holds especially true since companies, organizations and governments are adopting cloud computing at every level. Protocol standards are being debated here, and likely will never be universally agreed upon. This all furthers leads to the need for pluggable protocol architecture since different nodes, systems, clouds and devices will need to communicate using different protocols, at different times, for different reasons.

The platform needs to extend from the fore-mentioned enterprise, desktop and mobile/embedded environments down to the very nodes, sensors, and devices. This paves the way of providing Distributed Knowledge Networks (DKN) that extend to and integrates with Intelligent Sensor Networks (ISN).

The ISN will provide sensor instrumentation architecture with rules-based software agents that will provide self-monitoring, self-healing, non-intrusive data transfer methods. The architecture will also describe data routing, multi level security and delivery rules for node collaboration on networks. These robust ISNs will have the capability to reconfigure; self-heal/organize, and adjust to changing data needs and network node availability dynamically as an event evolves. They will do so by leveraging peer-to-peer and peer-to-group communication with like sensors nodes as well as more robust mobile and embedded devices. Logic to filter and analyze data, and distribution of more refined information the data, will occur where/whenever sufficient processing power and energy sources allow.

F) Location and PIM Peer-to-Peer and Peer-to-Group Services Module via PIM API 111

To enable location-aware, community-based, collaborative applications, the proposed pervasive platform will provide location and PIM services that allows determination of any node's location from any other node, as well as sharing of such information as contacts, calendaring, tasks and files (audio, video, photo, etc.). These services will form the building blocks of many ad-hoc, community-based applications. These APIs will be compliant with standards, such as BONDI, and be consistent across all platforms, languages and devices, and will be accessible by both peer-to-peer based messaging, peer-to-group messaging across dynamic communities and of course peer-to-enterprise/cloud for integration with enterprise systems, SAAS and IIAS clouds. In one embodiment, these capabilities may be provided by a Universal Location and PIM Sub-Module 29.

G) Universal UI API Module 16

The proposed pervasive platform will also provide a Universal UI API 16, to compliment its Universal API's for discovering, accessing and hosting services and data across all devices. Considered nearly an impossible task, technology has been described in the Applicant's co-pending patent application Attorney Docket No. 20091117.1, referenced above, to make this feasible in a standards-compliant, truly ubiquitous manner. More specifically, WebKit (based on HTML 5 and JavaScript 1.5) is becoming very prevalent on desktops and mobile devices. Android/Chrome, Apple/iPhone/Safari, Symbian/QT all have WebKit support within their corresponding platform's SDK via their own APIs and RIM have a similar platform under development. So WebKit and Microsoft's Silverlight seem to be poised to be the two dominant “web engines” across all devices. A Universal UI Interface that can communicate with WebKit and Silverlight, would allow developers to have their application process layer communicate with a JS/HTML presentation layer, all utilizing a single set of APIs.

H) Transactional on Edge Devices and Ad-Hoc Communities Capability

The proposed pervasive platform will extend transactions from the enterprise to edge devices, allowing for distributed, but coordinated tasks and information sharing and collaborative communications among peers, peer groups, enterprise, cloud, and federated clouds. Support will be provided to allow for intelligent agents/services running on the edge to participate in guaranteed service, message, and communication delivery either via an enterprise pub-sub JMS/MSMQ-like capability described above, or with XA-compliant enterprise transaction managers such as those provided in .NET's Microsoft Transaction Service (MTS), Java's Transaction Service (JTS), and OMG's Object Transaction Service (OTS).

I) Embedded and Enterprise Database Integration and Synchronization Module 18

This advanced platform will provide a simple way to access databases, regardless of the type of database—whether it is a relational, object, XML or a multi-user enterprise database or single-user embedded. Developers need to be shielded from the intricacies that exist with these various flavors and have support for data synchronization between a mobile/embedded device, the communities of devices it belongs to, and enterprise systems such as Software and Infrastructure-As-A-Service (SAAS, IAAS) Clouds. By providing this level of abstraction, pervasive applications built using this platform will be able to leverage the high-performance, highly distributed databases being developed for advanced, high-speed full-text searches that are making their way into non-traditional environments such as smartphones and routers.

J) Artificially Intelligent, Cognitive Edge Processing Module

A next-generation application will need to utilize intelligent software agents/services that can gather data, respond quickly based on this data as it changes, produce and distribute knowledge, and even initiate other agent/service activities on another device or group thereof. The underlying rules engine will be easy to use, provide very high performance against potentially large rule sets, and will be available in multiple languages. These agents will also be able to understand different ontologies as a powerful abstraction to the modeling of knowledge about different domains. This is accomplished by utilizing the Agents 110, Rules 19 and Ontology 17 API modules depicted in FIG. 1.

K) Support for Complex Event Processing (CEP)

The proposed pervasive platform with the capabilities described has the ability to filter and analyze data on any node and distribute resulting universal business/data to any other node, or interested groups of nodes regardless of their location and software platform.

The data will often originate from a wide range of sources often from sensory/mobile/embedded devices. The filtering, analyzing and distribution of information/events will first occur as close to the sensory/mobile/embedded device as possible (ideally on it). Such is the basis of the aforementioned ISN.

Additionally, the proposed pervasive platform will support dynamic groups that represent connected and/or hierarchical analysis/decision support/collaboration groups. Each level of groups analyzes micro events in determining relevant, increasingly coarsely grained, macro events leading to additional data/event filtering, analyzing, collaboration, response and also for determining the routing of that information to enterprise systems/clouds (governments, corporations, research institutions, trading floors, health organizations, etc.).

This results in the transformation of sensory data to knowledge (DKN) and ultimately to situational awareness and actionable knowledge in real-time or near real-time (CEP). The data traversing this ISN/DKN/CEP needs to be able to navigate firewalls, support (NAT), and be transportable to communities of disparate devices applications, systems and clouds that have expressed interest in receiving such data.

Every aspect of the platform's flexibility and support for heterogeneous the nodes, protocols, networks, messaging and discovery capabilities is fully leveraged in such a scenario.

Currently, the process of recording limitless sets of data from sensors, weapons, and communication and intelligence systems results in enormous unique data sets requiring extensive data Filter/Analysis to derive conclusions. The technology of this proposal will provide the logistics community with a network centric communications capability leading to the establishment of a Distributed Knowledge Network, which can operate with any combination of sensors/nodes/participants at various security and need to know levels of information exchange. The use of intelligent mobile agents can move the conduct of multi-service or joint network centric logistics planning into a new level of capability allowing the commander to have real-time knowledge of logistics information during the course of any operation. The two main areas of investigation proposed are providing Synthetic Instrumentation and Self-describing Smart Sensors via Intelligent Mobile Agent Architectures and Intelligent Software Agents and Distributed Knowledge Networks.

Using an agent-based architecture provides a solid solution capable of being deployed on any industry computing domains (including those with multi-level security and need-to-know domains). Typical uses for agent-based computing techniques are:
Reliability—Mobility and autonomy allow an agent to move from its point of origin into a network and continue to operate even if the originating device is disconnected from the network. By doing so, the agent provides services and satisfies predefined goals without user intervention.
Resource Optimization—If an agent's goals require extensive communication with a particular resource on the network, moving the agent closer to the resource reduces/eliminates network traffic allowing the agent to perform its duties more quickly. An agent can move from one node to another, so that it may communicate locally with a service resident on that node. Upon arriving at the node, the agent does not require a network connection and can communicate autonomously with the service to send or receive the desired information.
Distributed Parallel Processing—Agents can clone themselves and use other agents, breaking a main task into smaller subtasks to distribute the subtasks for parallel execution. One or more agents on multiple nodes can each perform these subtasks
Software Deployment—Mobility makes software deployment easy. Any application can be agent enhanced allowing the entire application to literally deploy itself to its final destination. This might be done to enhance performance, self-healing reasons, or for software updates of the agents themselves or the systems they are monitoring.

Recent advances in sensors and instrumentation systems with high throughput data, and digital information storage technologies, have made it possible to acquire, analyze and store large volumes of data in digital form. Advances in computers, communications, Internet, and mobile computing have made it possible to have large volumes of data, Filter/Analysis and decision support tools residing on multiple, geographically distributed, heterogeneous, hardware and software platforms around the globe. However, leveraging the advances in our ability to acquire, store, and analyze into gains in understanding and knowledge requires sophisticated tools for information retrieval, knowledge discovery, and distributed Filter/Analysis solving and decision-making in multi-level security and need-to-know environments.

Rapid and constant changes in hardware and software technologies related to tracking systems, monitoring devices, sensors, and other situational awareness tools requires a Data and Service Delivery Platform that provides a flexible, standards based data communication and integration system. Because of the increasing data entry points into the systems and the networks, this platform will require a capability to easily distribute analytical software code or task-based software objects to the data entry points of the systems or networks to effectively sort and analyze data at the source and then communicate more mature or specific knowledge across the systems or networks to lower network bandwidth utilization and route and deliver detailed data or actionable knowledge to enable more effective consumption of the data by appropriate systems, applications or users.

With the users entering data from various locations, this platform requires the ability to distribute the analytical or task-based software objects to the point of origin. By co-locating at the source, the software can perform initial sort and data Filter/Analysis required to refine the data set. The refining of the data before transmission results in lower network bandwidth utilization and more effective routing to the appropriate systems and/or users for action.

In order to lower life cycle management and technology upgrade costs, the data and service delivery platform will require the capability to distribute software updates dynamically (at different security levels) without disrupting the system. To efficiently distribute large volumes of data across a distributed network requires the capability to propagate messages across a connection of node “communities” or “spaces” that will increase speed and performance proportional to the number of nodes—in a sense creating a network of networks that scales dynamically.

Unique Capability Requirements:
Turn data into intelligence on edge devices and sensors
Distribute data using peer-to-peer and peer-to-peer group distribution paradigms
Dynamically aggregate network nodes into communities
Decentralized messaging supporting all major protocols
Distribute software updates dynamically to distributed devices
Enable transactional data relationships on distributed heterogeneous devices
Provide common, pluggable interface capabilities to heterogeneous devices and systems

A Distributed Knowledge Network (DKN) including Intelligent Software Agents (ISAs) is a technical architecture and distributed Filter/Analysis capability that will provide some of the key enabling technologies for translating recent advances in automated data acquisition, digital storage, computers and communications into fundamental advances supporting data Filter/Analysis, collaborative reviews and related applications

An ISA is a named object which contains software code, a persistent state, data and a set of attributes (requirements, history, authentication keys, etc.) and can move from one device or system as needed for accomplishing its tasks. Mobile agents provide an efficient framework for performing distributed computation at locations where the relevant data is available instead of expensive shipping of large volumes of data across the network. Most software agent designs consist of at least three components: agent servers, agent interfaces, and agent brokers (service directory). Agent servers support basic agent migration mechanisms, authentication, and sometimes provide other services. Agent brokers provide addresses of agent servers and support mechanisms for uniquely naming agents and agent servers. The agent interface is used by application programs to create and interact with agents.

ISA architecture is a valuable strategy due to the ability to:
Enable non-intrusive heterogeneous interoperability of devices, applications, databases and systems enabling ad-hoc integration and a pluggable architecture—the best aggregation of components for the specific task.
Reduce network load—Distributed instrumentation systems
often require many messages to achieve a task. Agents work distribution and local completion of tasks.
Overcome network latency—Network latency is not an issue as the task is local.
Encapsulate protocols—Distributed systems use protocols to define how messages and data are transferred. Modifying a protocol requires changing the code on all the sensors and machines in the system. Agents eliminate the need to alter code through encapsulation, the protocol accepts the agent and allows it work—creating a new agent can create new functionality.
Execute asynchronously and autonomously—Distributed mobile devices are not continuously connected to a network. Systems that require constant connections will not work on mobile devices. With agents, a mobile device can connect to the network to check for work/messages. An agent can be sent to the device and work even after the device disconnects. The agent can wait until the device is reconnected to report the result of its task.
Adapt dynamically—Agents can distribute themselves to networked machines that most effectively solve the current task.
Enables dynamic reconfiguration of software across distributed nodes and creates an adaptable network.
Provide scalability and fault-tolerance—If a host is being shut down or additional resources are required, an agent can move on to another host to continue to operate.

The agent performs its task and saves any results until its connection to the user is re-established. Mobile agents provide a reliable transport between a client and server without necessitating a reliable underlying communications medium.

Intelligent Software Agents & Knowledge Network Concepts

An Agent is software that assists with tasks and acts on behalf of the initiator. Agents are typically: goal-driven, reactive, social, adaptive and mobile. Agents have one or more of these characteristics:
Ongoing Execution—Agents run for a long time
Autonomy—Agents do not require human supervision to function
Character—Agents have personality, and exhibit human-like qualities
Adaptive—Agents adapt to their environment and customize themselves to the preferences of their user
Agent awareness—Agents can communicate and interact with other agents
Mobile—Agents can move around on the network

The many features of a robust, intelligent, self-managing agent platform and the various types of agents provide for a very powerful, non-obtrusive, monitoring, healing and problem-solving capability. Specifically, the more challenging and diverse an environment is, the more an intelligent, agent-based approach will be considered. Next-generation solutions for mobile applications will provide a high level of security to ensure privacy, and protection from rogue/viral processes. This is most effectively accomplished via security software agents and agent managers that provide capabilities above and beyond the current encryption, authentication and authorization that are currently employed in today's centralized client server applications.

Intelligent software agents can reside on any heterogeneous device or node such as sensors, readers, cameras, PDA's, smart phones, desktops, laptops, tablets, servers and mainframes. Additionally they can execute effectively within any software architecture from thick and thin client-server applications to widely decentralized applications or DKNs. More specifically, at any point in time a node will be acting as a client or server. Briefly multi-level, role-based security is often accomplished as follows:
All node-to-node distributed communication is encrypted using a pluggable protocol framework that can allow for SSL, TLS or other government implementations utilizing public key cryptography. Intelligent mobile agents will travel with public keys, but only agent managers will contain private keys, which will be accessible to a simulation agent arriving or resident at a node, only upon verifying the agent with the security agent manager.
Authentication is accomplished using X.509 client and site certificates. Site certificates can be resident at each processing node, and again are overseen by security agent managers. Simulation agents will travel with client certificates containing its role information, as well as the identity and roles of the Administrator deploying it (see below).
Authorization of Users, Customers, Administrators and even DKN processes within applications or tools are based on assigned roles, using a Role-Based Access Control Architecture (RBAC). In turn, Super Users assigned to key applications, systems and/or domains, with the highest level of security clearance, will be responsible for assigning roles to Administrators.
Agent managers' resident on nodes actually participating in a DKN network, will verify and validate any arriving intelligent mobile agents using the same RBAC architecture. The client certificate, containing identity, key, and role information will be used by the Security Agent Manager to determine if the Agent may arrive at its node and execute the process desired.
A Software Agent Administrator assigns agent roles using Agent Monitoring tools. The Administrator uses the same tool for the creation of public and private keys and X.509 Certificates, as well as their association with Agents and DKN nodes.
Administrator tool-based security is performed by a security Agent Manager resident on the management application nodes. The role of the administrator will be used to determine what capabilities he or she can perform, such as creation of keys, certificates, association of such with Agents and nodes, and deployment, management, and monitoring of Agents and the DKN processes for which they are responsible.

The innovative capabilities of a DKN will enhance advances in scientific research and military operational test and training applications (e.g., intelligence data handling, situation assessment, command and control, network centric warfare). DKNs will significantly reduce the total ownership costs of new weapon systems while enhancing force readiness in a non-intrusive manner. There is also opportunity in many other areas for enhancement and improvement of information retrieval, knowledge discovery, and distributed Filter/Analysis for problem solving and decision-making. The proposed technology and design can improve crisis management and communications infrastructure, which offer numerous scenarios that require reactive as well as proactive decision-making, often under tight time, resource, and performance constraints to accomplish the desired objectives.

A software platform with the described pervasive features and inherit Distributed Knowledge Network and Intelligent Sensor network capabilities brings revolutionary capabilities and ease of use to today's application architects. It gives them maximum flexibility to develop dynamic, intelligent, and decentralized applications in .NET, Java and C++ on the devices and servers they need to target. Additionally, the extensive protocol support—in combination with its multi-language support and SOA—allows the intelligent mobile agents in these applications to access systems written in any language. They can also be accessed by systems written in any language in a variety of ways and messaging techniques, be they centralized or decentralized. By leveraging the AI rules integration and the pervasive mobile agents residing on any and all targeted devices and servers, organizations could create applications that provide real-time intelligence, coordination, and capabilities not found today.

There is great deal of momentum behind enterprises moving toward the .NET architecture, but there's a lot of Java, CORBA, and mainframe systems in many of these same organizations.

A very similar situation exists in the device world. Android is gaining speed and acceptance among device makers, but devices running iPhone, Symbian, embedded Linux (LiMo and Meego), Windows Mobile and PalmOS will likely always exist. This unifying platform will allow next-generation applications to exist seamlessly in this diverse software environment and the increasingly diverse wired and wireless networks they are running on.

This platform would provide the capability to create a new set of applications that are distributed knowledge and problem-solving networks with dynamic and ad hoc participants using different devices and enterprise software systems. It's not hard to see where this could be of great benefit in the domains of disaster recovery, terrorist response, and homeland security to name only a select few applicable areas in the government. In the commercial arena, the energy, transportation, insurance, education, telecom, healthcare, and finance industries are obvious verticals that could create vast new opportunities with such a platform. Indeed there's not a vertical in the commercial, government, or consumer arena that could not create revolutionary new capabilities with such a platform to leverage and use.

Further details of applications and code generation for the pervasive platform are described in the Applicant's co-pending patent application Attorney Docket No. 20080529.2, referenced above.

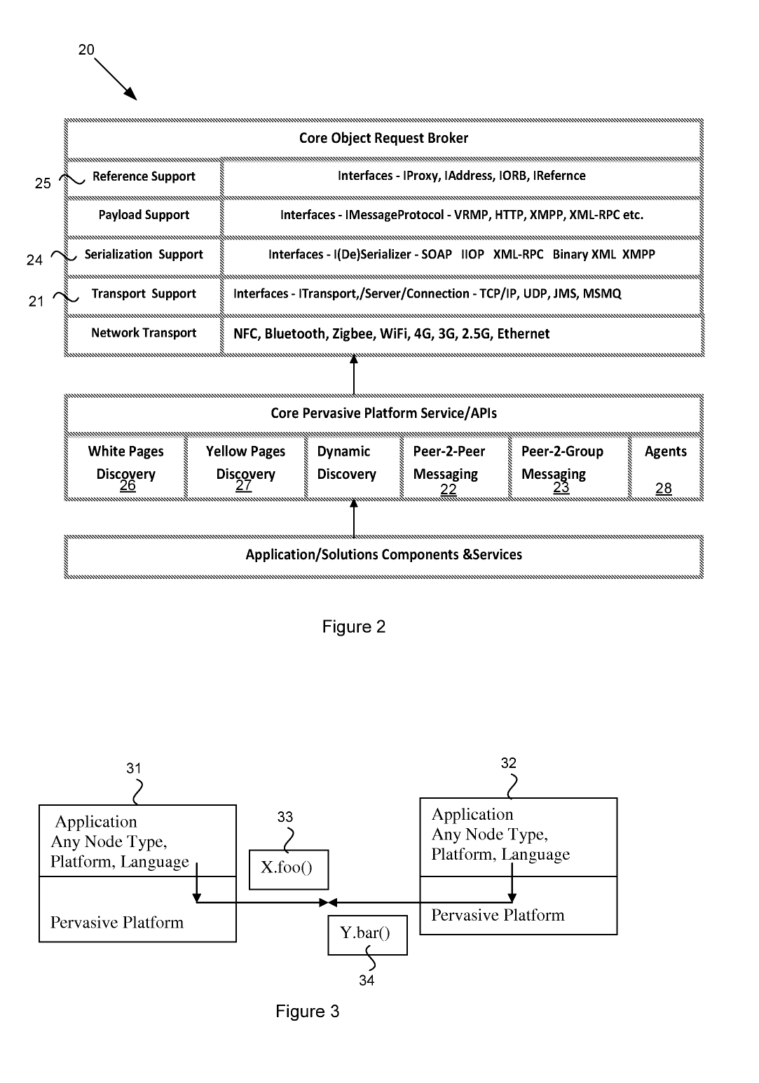

FIG. 2 is a layered view of the Pervasive Platform's Service Container. The platform 20 provides the one-stop capabilities needed to build advanced applications as described above that span enterprises, networks and devices. The platform integrates the various layers through a set of Universal APIs, providing a single platform that extends from the sensor to the cloud and everything in-between.

By universal, it is meant that the system caters for the world's common and prominent devices, networks, operating systems, software languages, software protocols etc. Being universal allows the platform to implement applications on the world's major servers, desktop/laptops, MID/UMPC/Netbook/Tablets, smart-phones, embedded and smart-sensor operating systems, etc.

Pervasive Software Platform Universal Core Request Brokering Sub-Modules

A) Pervasive Software Platform Universal Transport Interface

A Transport Interface 21 that allows for communicating via multiple transports both IP-based (TCP-IP, UDP, JMS, MSMQ) and non-IP based (Bluetooth, Zigbee, NFC). A specific implementation is determined via the Peer-2-Peer 23 and Peer-2-Group 24 messaging APIs. The Pervasive Platform determines which underlying network protocol to utilize based on rules that weigh performance, cpu utilization, network bandwidth, etc. Peer-2-Peer and Peer-2-Group messaging can occur over multiple transports within the same application.

B) Pervasive Software Platform Universal Serialization Interface

A Serialization Interface 24 that allows for communicating via multiple data serialization standards (Binary Objects, XML, JSON, XMPP) to be supported within various the payloads of various distributed protocols. A specific serialization is determined via the Peer-2-Peer and Peer-2-Group messaging APIs 22, 23. The Pervasive Platform decides on what serialization implementation to use, based on a similar ruleset which weighs performance, cpu utilization, network bandwidth, network connectivity support.

So within the same application, Peer-2-Peer and Peer-2-Group messaging can occur over multiple transports and multiple payload serialization protocols.

C) Pervasive Software Platform Universal Dist. Protocol/Remote Interface

A Distributed Protocol Interface 25 that allows for communicating via multiple distributed protocols standards (VRMP, SOAP, XMPP, etc), in a Peer-2-Peer and Peer-2-Group manner. A specific distributed protocol is determined via the Peer-2-Peer and Peer-2-Group APIs 22, 23. So within the same application, Peer-2-Peer and Peer-2-Group messaging can occur using multiple distributed protocols, those in turn use multiple payload serialization standards, while running over various transports.

Features and functions of the Pervasive Software Platform Universal Peer-2-Peer Messaging Sub-Module 22 include

Implicit:
Synchronous through a proxy,
Interface oriented: proxy implements the application interface,
Proxy objects dynamically generated for all platforms,
Tooling for build-time generation (all platforms),
Transparent to the application developer.

Explicit:
Synchronous, One-Way, Delayed Synchronous, Asynchronous
   Enables invocation of arbitrary methods, including class methods
   Supports method overloading

The Peer-2-Peer Messaging sub-module 22 manages changing and multiple addresses on both the “client” node and the “server node”. The addresses may be based on IP, Zigbee, Near Field Communication or Bluetooth protocols/addressing/identification.

FIG. 3 depicts two nodes communicating Peer-2-Peer. More specifically, the left node 31, is executing a Method foo( ) 33 on Service X that is running on the right node 32. Conversely, the right node, is executing a Method bar( ) 34 on Service Y, that is running on the left node. Remote references (a.k.a Proxies) are created by disovering the services either via White Pages Server (by name), Yellow Pages Server (by description) or via UDP-based Dynamic Discovery. The messaging can be synchronous, one-way, delayed or asynchronous. The Pervasive Platform resident on each node, enables this Peer-2-Peer messaging between potentially heterogeneous nodes.

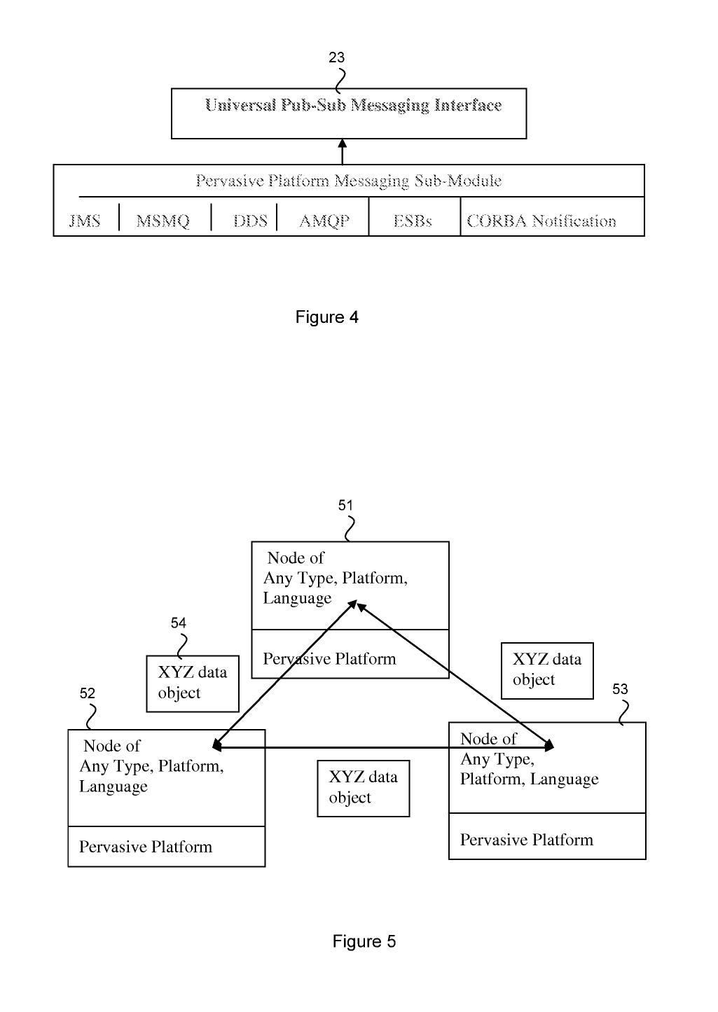

FIG. 4 through FIG. 12 depict the Universal API's and the underlying technologies that they abstract and provide a single interface into.

Features and functions of the Pervasive Software Platform Universal Peer-2-Group Messaging Sub-Module 23 include:

Multicast Messaging:
Using UDP,
Using Logical Groups over:
   TCP,
   Choice of JMS, MSMQ, Corba Notification for reliable multicasting,
   Offers filtering at source and/or destination, Looks like a method invocation through a proxy.

Publish and Subscribe:

FIG. 4 depicts the Universal publish-and-subscribe abstraction API. The API provides quality of servers and filtering, that is ultimately supported by the underlying JMS, MSMQ, CORBA Notification, DDS, AMQP, ESBs. Filtering is implemented via topics that are:
Subject oriented, via user-defined topics,
Supports hierarchical naming of topics,
Event oriented, via language event model.

The Universal Pub-Sub API may include the following interface.

1) An Interface which Allows You to Publish/Subscribe to data by Topic:
a) void close( );
b) Object getAddress( )
c) Object getListener( )
d) Object getSession( )
e) Object receive( )
f) Object receive(String selector)
g) List receiveAll( )
h) void releaseResources( )
i) void removeAll( )
j) Object request(Object payload)
k) void send(Object payload)
l) void sendAll (List payloads)
m) void setListener(MessageListener listener)

2) A Callback Interface which Allows You to Receive Messages:
a) boolean onMessage(Object message);

There is Pub-Sub Messaging Factory, which loads an instance of the appropriate class that implements the above Pub-Sub interface; based on the platform the application is running on and configuration settings describing the type of publish and subscribe messaging capability desirable on such a platform.

The implementation class is exposed as a remotely accessible object via the first interface described above. The object is bound to the Universal Directory, with a well-known name. From that point on the local application simply communicates with the Universal Pub-Sub Messaging interface described above. Remote nodes can communicate with the remotely accessible interface, by discovering it via the Universal Directory, based on its well-known name.

FIG. 5 depicts a group of 3 heterogeneous or homogeneous nodes 51, 52, 53 that are publishing and subscribing (a.k.a. pushing and pulling) data. More specifically the data being pushed is an XYZ Data Object 54. The Pervasive Platform running on each node, allows for the Peer-2-Group messaging of this data object across potentially heterogenous communities of nodes. The communities of nodes are virtual and can be created at runtime using the Pervasive Platform's Peer-2-Group API's. Once created, any node running the Pervasive Platform can join/leave an unlimited number of virtual groups/communities.

Pervasive Software Platform Universal White Pages Sub-Module

The Universal White Pages API 26 is a White Pages Interface that allows for discovering services by name. A specific implementation is utilized via a configuration file and implementations can be centralized, decentralized, persistent or transient. Implementations can utilize “Naming Servers” from Enterprise Software stacks such as CORBA's Naming Service (CosNaming), JEE's Java Naming and Directory Interface (JNDI), Lightweight Directory Access Protocol (LDAP) or .NET's Windows Communication Foundation (WCF)

The white pages API 26 may be created by an abstraction of the API's that are out there for the different types of White Pages (Service discovery by name) implementations outlined. Implementations of that interface can then be created that can communicate with the most common commercial and open-source implementations of White Pages.

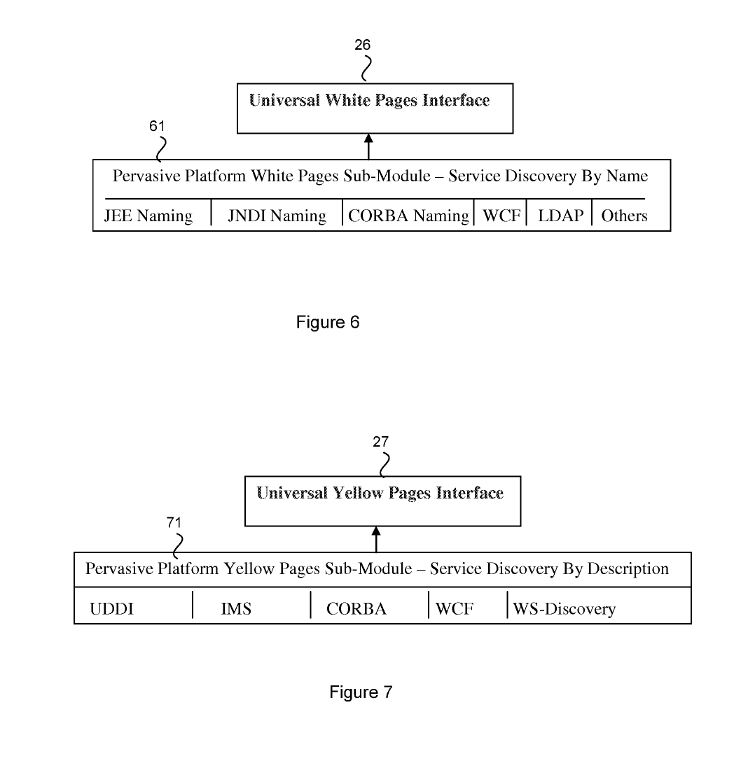

FIG. 6 depicts the Universally available API for accessing a Service by Name. The underlying White Pages implementation 61 is established via a configuration option to the Pervasive Platform runtime. Any node, running the Pervasive Platform, wishing to discover a service by its Name can discover it, by utilizing this API, regardless of the White Pages server implementation being utilized.

The Universal White Pages API consists of the following interface.

1) An Interface which Allows You to Access or Register a Service by Name:
a) connect(IWhitePages aWhitePages);—connect aWhitePages to this one
b) disconnect(IWhitePages aWhitePages);—disconnect aWhitePages to this one
c) register(String aObjectName, Object aObject);—registers Objects to White Pages by Name
d) deregister (String aObjectName, Object aObject);—deregisters Objects from White Pages by Name
e) reregister(String aObjectName, Object aObject);—re-registers Objects to White Pages by Name
f) Proxy lookup(String aObjectName);—looks up an Object in White Pages by Name, returning a Proxy (i.e. Remote Reference) to it

There is White Pages Factory, which loads an instance of the appropriate class that implements the above interface; based on the platform the application is running on and configuration settings that describe the type of white pages desirable on such a platform. The implementation class is exposed as a remotely accessible object via the first interface described above. The object is bound to the Universal Directory, with a well-known name. From that point on the local application simply communicates with the Universal White Pages interface described above. Remote nodes can communicate with the remotely accessible interface, by discovering it via the Universal Directory, based on its well-known name.

Pervasive Software Platform Universal Yellow Pages Sub-Module

There is a Yellow Pages Interface 27 that allows for discovering services by description. Implementations can be centralized, decentralized, persistent or transient. Implementations can utilize “Yellow Pages Servers” such as UDDI, IMS, CORBA Trading Service, WS-Discovery etc.

The yellow pages API 27 may be created by creating an abstraction of the API's that are out there for at least the common and prominent types of Yellow Pages (Service discovery by description) implementations outlined. Implementation of that interface can then be created that can communicate with the most common commercial and open-source implementations of Yellow Pages.

FIG. 7 depicts the Universally available API 27 for accessing a Service by Description. The underlying Yellow Pages implementation 71, is established via a configuration option to the Pervasive Platform runtime. Any node, running the Pervasive Platform, wishing to discover a service by its Description can discover it, by utilizing this API, regardless of the Yellow Pages server implementation being utilized.

The Universal Yellow Pages API may include the following interface.

1) An Interface which Allows You to Access or Register a Service by Name:
a) connect(IYellowPages aYellowPages);—connect aYellowPages to this one
b) disconnect(IYellowPages aYellowPages);—disconnect aYellowPages to this one
c) register(ServiceDescription aServiceDescription, String aObjectName, Object aObject);—registers Objects to Yellow Pages by ServiceDescription
d) deregister (ServiceDescription aServiceDescription, String objectName, Object aObject);—deregisters Objects from Yellow Pages by ServiceDescription and Name
e) reregister(ServiceDescription aServiceDescription, String aObjectName, Object aObject);—re-registers Objects to Yellow Pages by ServiceDescription and Name
f) List lookup(ServiceDescription aServiceDescription);—looks up Objects in Yellow Pages by ServiceDescription, returning a List of Proxies (i.e. Remote References) to it

There is Yellow Pages Factory, which loads an instance of the appropriate class that implements the above interface; based on the platform the application is running on and configuration settings describing the type of yellow pages desirable on such a platform. The implementation class is exposed as a remotely accessible object via the first interface described above. The object is bound to the Universal Directory, with a well-known name. From that point on the local application simply communicates with the Universal Yellow Pages interface described above. Remote nodes can communicate with the remotely accessible interface, by discovering it via the Universal Directory, based on its well-known name.

Pervasive Software Platform Universal User Interface Sub-Module

A UI API that allows for communicating bi-directionally with the platforms underlying web-engine (WebKit, IE/Silverlight etc) via JavaScript and support HTML 5. The UI API 28 allows for Bi-directional communication between Application Process Layer and Presentation Layer utilizing Universal API's of the Pervasive Computing Platform 20.

A specific implementation is utilized via a configuration file and is typically dictated by the underlying Native Platform (e.g. Android, iPhone, Windows etc). The UI API 28 may be created from an abstraction of the Web-engine-based API's that are out there for the different types of device/platforms outlines. Implementations of that interface can then be created that can communicate with the most common commercial and open-source implementations of those web-engines.

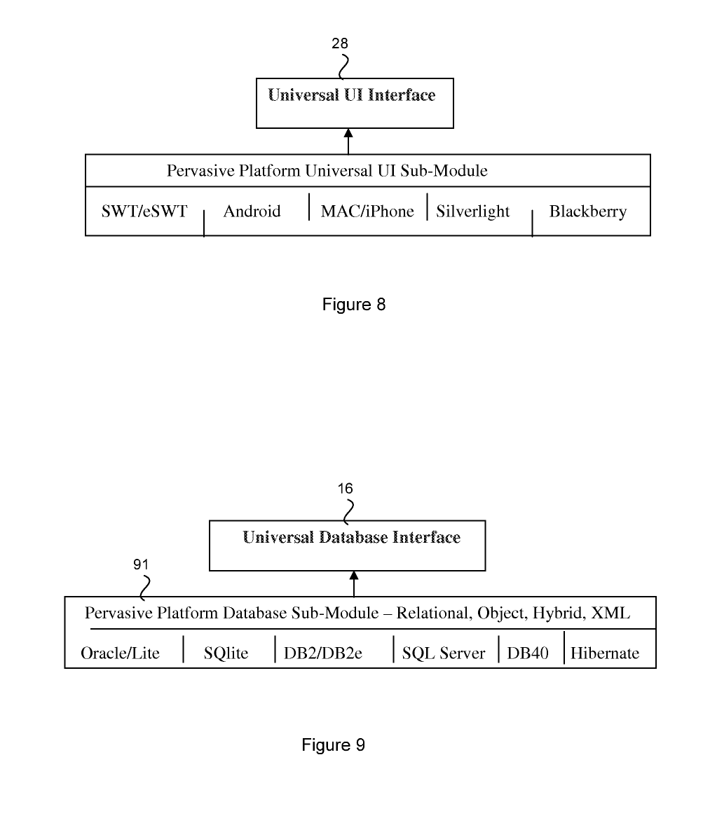

FIG. 8 depicts the Universally available API for bi-directional communication between a native application and the underlying native web-engine on the local node. The underlying web engine, is determined via a configuration option to the Pervasive Platform runtime. Any node, running the pervasive platform, wishing to have their native application contain a user interface that is described in Javascript/HTML/CSS can do so, by utilizing this API, regardless of the underlying web-engine engine being utilized. The Universal API supports callbacks from javascript methods to the native application. Examples of these types of web-engines are shown in FIG. 8.

This User Interface API may also be made to be remotely accessible to other devices on the network. The result is remote devices can access and/or update the presentation layer of the application running on a given device. This is accomplished by using the Pervasive Software Platform Universal Peer-2-Peer Messaging Sub-Module 22 and Pervasive Software Platform Universal Peer-2-Group Messaging Sub-Module 23.

The Universal UI Interface may include the following two interfaces.

1) A Remotely Accessible Interface, which Represents the Type of Actions that can be Done to Render or Access a User Interface's State
a. loadHtmlData (String htmlAndJavascript)—updates the WebView with HTML provided
b. loadUrl (String aUrl)—updates the WebView with the contents from the URL provided
c. updateHtml(String aHtmlObjectName, String aHtmlObjectValue)—
d. addJavascriptInterface(Object aCallbackObject, String aCallbackName)
e. String getHtml( )—gets the current html containted within the WebView

2) A Locally Accessible Interface, which Represents Additional Actions that are Needed to Interact with the Underlying User Interface Engine
a. setContext(Object)—set the application context for the Universal UI
b. addPageToApplicationFrame(Object, Object)—adds the WebView Page to the Application Frame
c. getNativeBrowserUIObject( )—returns the native Browser WebView UI Object

There is Universal UI Factory, which loads an instance of the appropriate class that implements the above interfaces; based on the platform the application is running on. The implementation class is exposed as a remotely accessible object via the first interface described above. The object is bound to the Universal White Pages, with a well-known name. From that point on the local application simply communicates with the Universal UI interface described above. Remote nodes can communicate with the remotely accessible interface, by discovering it via the Universal White Pages, based on its well-known name.

Pervasive Software Platform Universal Database API

A Universal Database Interface that allows for persisting to a wide array of databases is shown in FIG. 1 as Database API/Database Engine 16.

A specific implementation is utilized via a configuration file. Implementations can be relational, object, object-relational, XML etc. These databases may exist in the enterprise, mobile and/or embedded environments.

The Universal Database API may be created from an abstraction of the API's that are out there for the different types of databases outlined. Implementations of that interface can then be created that can communicate with the most common commercial and open-source implementations of databases.

FIG. 9 depicts the Universally available API for persisting and retrieving data from a database on the local node. The underlying database engine 91, is selected via a configuration option to the Pervasive Platform runtime. Any node, running the pervasive platform, wishing to persist or retrieve data can do so, by utilizing this API, regardless of the underlying database engine being utilized. The types of databases supports will be relational, object-relational and XML-based databases. Examples of these types of databases are shown in FIG. 9.

This Database API may also be made to be remotely accessible to other devices on the network. The result is remote devices can access and/or update data on a given device. This is accomplished by using the Pervasive Software Platform Universal Peer-2-Peer Messaging Sub-Module 22 and Pervasive Software Platform Universal Peer-2-Group Messaging Sub-Module 23.

The Universal UI Database may include:

1) An Interface, (UniversaIDBAction) which represents the type of actions that can be done on a database:
a) UniversaIDBAction addUpdate(String dbQuery);—adds an update query
b) UniversaIDBAction addUpdate(String dbQuery, Object[ ] replacementParms);—adds an update query with replacement parameters
c) UniversaIDBAction addQuery(String dbQuery, Object type);—adds a query with an object that will contain the result set for each row
d) UniversaIDBAction addQuery(String dbQuery, Object type, Object[ ] replacementParms);—adds a query with query parameters and with an object that will contain the result set for each row,
e) UniversaIDBAction addQuery(String dbQuery, Object[ ] replacementParms);
f) UniversaIDBAction addQuery(String dbQuery);—adds a Query
g) int sqlSize( );—gets the size of the current set of SQL statements
h) UniversaIDBAction clear( );—clears the current set of SQL statements
i) List execute(IJDBCProperties info);—executes the current set of SQL statements

There is Database Factory, which loads an instance of the appropriate class that implements the above interfaces; based on the platform the application is running on and configuration settings describing the desired database type. The implementation class is exposed as a remotely accessible object via the first interface described above. The object is bound to the Universal White Pages, with a well-known name. From that point on the local application simply communicates with the Universal Database interface described above. Remote nodes can communicate with the remotely accessible interface, by discovering it via the Universal White Pages, based on its well-known name.

Pervasive Software Platform Universal Location and PIM Sub-Module

A universal Location and PIM Sub-Module 15 is depicted in FIG. 1. The sub-module 15 provides a Location Interface that allows for access location and PIM (contact, calendar, task) data from a wide array of location technology's/platform specific API's. A specific implementation may be utilized via a configuration file. Implementations include those for Java, Windows, Apple, Android and other devices/platforms

These API's may also be made to be remotely accessible to other devices on the network. This allows for remote devices to access location information and retrieve/update PIM data on other devices. This is accomplished by using the Pervasive Software Platform Universal Peer-2-Peer Messaging Sub-Module 22 and Pervasive Software Platform Universal Peer-2-Group Messaging Sub-Module 23.

The sub-module 15 may be created by first creating an abstraction of the API's that are out there for the different types of Location APIs available on the most popular platforms/devices. Implementations of that interface can then be created that can communicate with the most common commercial and open-source Location determination implementations.

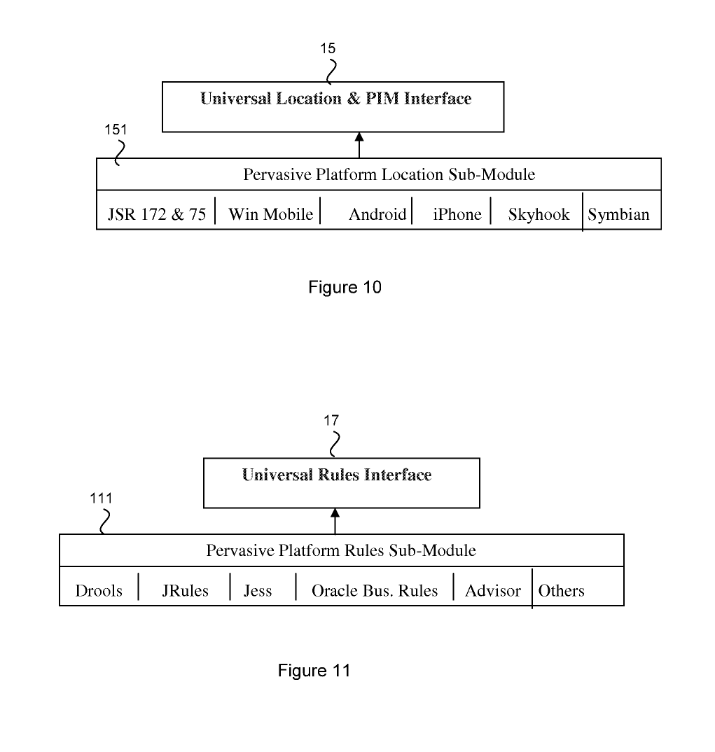

FIG. 10 depicts the Universally available API 15 for retrieving current location information and retrieving/updating PIM (Contact, Calendar, Task) information from the local node. The underlying location engine 151 and PIM database, is determined via a configuration option to the Pervasive Platform runtime. Any node, running the pervasive platform, wishing to determine its current location or access PIM information can do so, by utilizing this API, regardless of the underlying location engine or PIM database being utilized. The types of location engines and PIM engines are very often, though not always, part of a particular device's native platform. Examples of these types of location engines are shown in FIG. 10.

The Universal PIM Interface may include:

1) A Contact Interface, which represents the type of actions that can be done on a Contact:
a. addContact(Contact aContact);—adds a Contact
b. updateContact(Contact aContact);—updates a Contact
c. deleteContact(Contact aContact);—deletes a Contact
d. List queryContact(String aQuery);—queries a Contact returning a List

2) A Calendar Interface, which represents the type of actions that can be done on a Calendar Event:
a. addCalendarEvent(CalendarEvent aCalendarEvent);—adds a Calendar Event
b. updateCalendarEvent (CalendarEvent aCalendarEvent);—updates a Calendar Event
c. deleteCalendarEvent (CalendarEvent aCalendarEvent);—deletes a Calendar Event
d. List queryCalendarEvent (String aQuery);—queries a Calendar Event returning a List

3) A Task Interface, which represents the type of actions that can be done on a Task:
a. addTask(Task aTask);—adds a Task
b. updateTask (Task aTask);—updates a Task
c. deleteTask (Task aCalendarEvent);—deletes a Task
d. List queryTask (String aQuery);—queries a Task returning a List

The Universal Location Interface consists of:

4) A Location Interface, which represents the type of actions that can be done on a Contact:
a. Location getCurrentLocation( )—gets Current Location
b. Location getCurrentLocation(Criteria aCriteria);—gets Current Location based on Criteria

There is PIM and Location Factory, which load an instance of the appropriate class that implements the above interfaces; based on the platform the application is running on and configuration settings. For Location, the implementation class could be for a 3rd party location capability. The implementation class is exposed as a remotely accessible object via the first interface described above. The object is bound to the Universal White Pages, with a well-known name. From that point on the local application simply communicates with the Universal PIM and Location interfaces described above. Remote nodes can communicate with the remotely accessible interface, by discovering it via the Universal PIM and Location, based on its well-known name.

Pervasive Software Platform Universal Rules Sub-Module

A Rules Interface 17 that allows for execution of rule sets (bound to business objects) that are executed within a wide array of rules/inference engines base on abstraction of JSR is depicted in FIG. 1. A specific implementation is utilized via a configuration file. Implementations may include those for Drools, JRules, Jess, Oracle Business Rules, FICO Advisor etc.

The Universal Rules Engine API 17 may be created by first creating an abstraction of the API's that are out there for the different types of Rules APIs available on the most popular platforms/devices. Implementations of that interface can then be created that can communicate with the most common commercial and open-source Rule-engine implementations.

FIG. 11 depicts the Universally available API 17 for executing rules on the local node. The underlying rules engine 111, is selected via a configuration option to the Pervasive Platform runtime. Any node, running the pervasive platform, wishing to execute rules can do so, by utilizing this API, regardless of the underlying rules engine being utilized. The types of rules engines supported will be RETE-based and rules engines. Examples of these types of databases are shown in FIG. 11.

This Rules API may also be made to be remotely accessible to other devices on the network. This allows for remote devices to execute rule sets on other devices. This is accomplished by using the Pervasive Software Platform Universal Peer-2-Peer Messaging Sub-Module 22 and Pervasive Software Platform Universal Peer-2-Group Messaging Sub-Module 23.

The Universal Rule Interface may include:

1) An Rule Interface, which represents the type of actions that can be done on a Rule Engine:
a. Object[ ] getRuleSetMetadata( )—Returns the meta data for the rule execution set bound to this rule session.
b. int getRuleSessionType( )—Returns the type identifier for this Rule Session
c. void terminateRuleSession( )—Releases all resources used by this rule session
d. Object[ ] executeRules(Object[ ] objects)—Executes the rules in the bound rule execution set using the supplied list of objects
e. Object[ ] executeRules(Object[ ] objects, Object[ ] filter)—Executes the rules in the bound rule execution set using the supplied list of objects
f. Object addObject(Object aObject)—Adds a given object to the rule session state of this rule session, returning its ID
g. List addObjects(Object[ ] objList)—Adds an Array of Objects to the rule session state of this rule session.
h. boolean containsObject(Object aObjectID)—Returns true if the given object is contained within rule session state of this rule session.
i. void executeRules( )—Executes the rules in the bound rule execution set using the objects present in the rule session state.
j. Object[ ] getIDs( )—Returns an Array of the IDs being used for object identity.
k. Object getObject(Object ruleSessionID)—Returns the Object within the stateful rule session associated with a Handle.
l. Object[ ] getObjects( )—Returns an Array of all objects in the rule session state of this rule session.
m. Object[ ] getObjects(Object[ ] filter)—Returns an Array over the objects in rule session state of this rule session.
n. void removeObject(ID objectId)—Removes a given object from the rule session state of this rule session.
o. void reset( )—Resets this rule session.
p. void updateObject(Object objectID, Object newObject)—Notifies the rules engine that a given object in the rule session state has changed.

There is a Rule Engine Factory, which load an instance of the appropriate class that implements the above interface; based on the platform the application is running on, as well as configuration information describing any particularly desired agent platform. The implementation class is exposed as a remotely accessible object via the first interface described above. The object is bound to the Universal White Pages, with a well-known name. From that point on the local application simply communicates with the Universal Rule interface described above.

Pervasive Software Platform Universal Agent Sub-Module

An Agent Interface 28 that allows for Agents to interoperate with multiple Agent Framework/Platforms is depicted in FIG. 2. A specific implementation is utilized via a configuration file. Implementations may include those for Voyager, Jade JACK, SPADE, Cougar, JIAC and other FIPA compliant Agent platforms. The agent interface API 28 may be created by first creating an abstraction of the API's that are out there for the different types of Agent APIs available on the most popular platforms/devices. Implementations of that interface can then be created that can communicate with the most common commercial and open-source Agent implementations.

There will be a default Agent Framework/Platform that comes with the Pervasive Software platform, which is described in greater detail below.

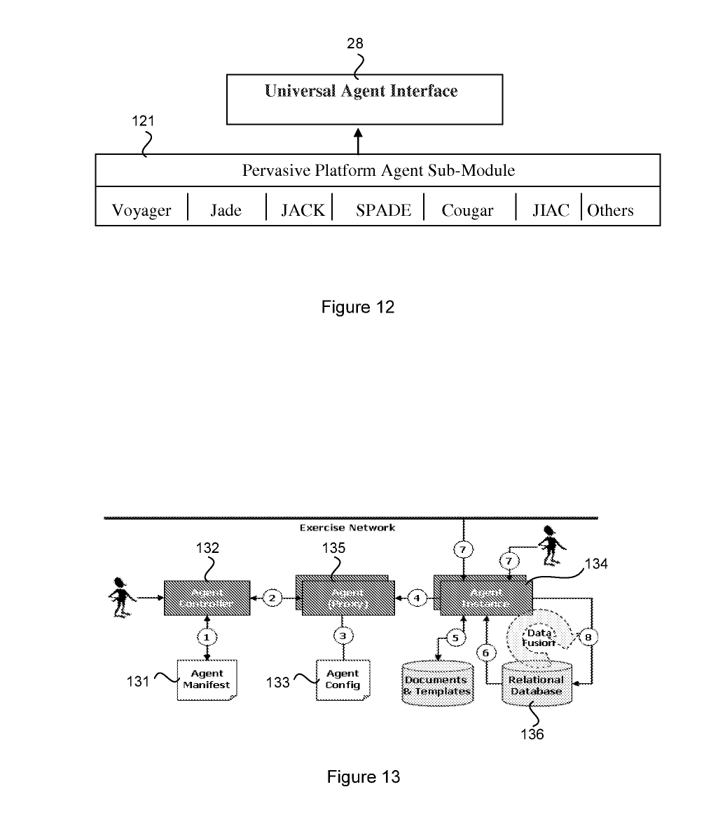

FIG. 12 depicts the Universally available API 28 for creating, managing, moving and executing software agents. The underlying agents engine 121, is selected via a configuration option to the Pervasive Platform runtime. Any node, running the pervasive platform, wishing to create/access/host autonomous software agents, can do so, by utilizing this API, regardless of the underlying agent engine being utilized. Examples of these types of the underlying agent platforms that may be supported are shown in FIG. 12.

The Universal Agent Interface may include:

1) An Agent Interface, which represents the type of actions that can be done on a Software Agent:
a. void addBehaviour(Behavior b)—adds a new behavior to the agent.
b. void afterMove( )—Actions to perform after moving.
c. void beforeMove( )—placeholder shall be overridden by user defined agents to execute some actions before the original agent instance on the source container is stopped (e.g. releasing local resources such as a GUI).
d. Message blockReceive( )—receives an ACL message from the agent message queue.
e. Message blockReceive(long millis)—Receives an ACL message from the agent message queue, waiting at most a specified amount of time.
f. void activate( )—Make a state transition from suspended to active or waiting (whichever state the agent was in when doSuspend( ) was called) within Agent Platform Life Cycle.
g. void clone(Location destination, String newName)—Make this agent be cloned on another location.
h. void delete( )—Make a state transition from active, suspended or waiting to deleted state within Agent Platform Life Cycle, thereby destroying the agent.
i. void move(Location destination)—Make this agent move to a remote location.
j. void suspend( )—Make a state transition from active or waiting to suspended within Agent Platform Life Cycle; the original agent state is saved and will be restored by a doActivate( ) call.
k. void wait( )—Make a state transition from active to waiting within Agent Platform Life Cycle.
l. void wait(long millis)—Make a state transition from active to waiting within Agent Platform Life Cycle.
m. void wake( )—Make a state transition from waiting to active within Agent Platform Life Cycle.
n. State getAgentState( )
o. ID getID( )—queries the private Agent ID.
p. ID getAMS( )—Get the Agent ID for the platform AMS.
q. Object[ ] getArguments( )—Get the array of arguments passed to this agent.
r. Object getController( )—Return a controller for the container this agent lives in.
s. ID getDefaultDF( )—Get the Agent ID for the platform default DF.
t. String getHap( )—queries the Home Agent Platform.
u. String getName( )—queries the agent complete name (GUID).
v. Location here( )—retrieves the location this agent is currently at.
w. boolean is Restarting( )—returns true when this agent is restarting after a crash.
x. void postMessage(Message msg)—Put a received message into the agents queue.
y. void putBack(Message msg)—Puts a received ACL message back into the queue.
z. Message receive( )—Receives an ACL message from the agent message queue.
aa. void removeBehavior(Behavior b)—removes a given behavior from the agent.
bb. void send(Message msg)—Send an ACL message to another agent.
cc. void setQueueSize(int newSize)—Set message queue size.
dd. void setup( )—empty placeholder for application specific startup code.
ee. void takeDown( )—empty placeholder for application specific cleanup code.

There is an Agent Factory, which load an instance of the appropriate class that implements the above interface; based on the platform the application is running on, as well as configuration information describing any particularly desired agent platform. The implementation class is exposed as a remotely accessible object via the first interface described above. The object is bound to the Universal White Pages, with a well-known name. From that point on the local application simply communicates with the Universal Agent interface described above.

The following is a description of the proposed Agent Framework, which runs on the proposed Pervasive Software Platform described above.

In general Agents are used to integrate service tool sets and other capabilities with the DKN. As additional components continue to be integrated, Agent Frameworks help control and manage the maintenance required for that integration over time.

Agent Communications Description

Agents are used as a means of communication between components of a system oriented architecture (SOA). Agents translate instructions from an agent controller in context to the DKN component they integrate with as a proxy. This process is depicted in FIG. 13.

(1) Agent Manifest 131 communicates to the server the agents (federates) to be loaded on nodes across the network.

(2) The Agent Controller 132 communicates to each agent (federate) the configuration to use in the conduct of its work.

(3) The Agent Configuration 133 communicates to the agent the work to be conducted in the form of an instanced software component (class and class path) and other configuration items.

(4) The Software Instance 134 for an agent is loaded or connected to the Agent Proxy 135.

(5) Ontologies and Rule-Sets that communicate the vocabulary, structure and type of data retrieval and collection (feedback) needed to conduct its work.

(6) The Knowledge Repository Database 136 communicates to the Agent data as input to the work to be conducted.

(7) The Agent client/instance 134 communicates inputs/results from network, GUI, Filter/Analysis to the Knowledge Repository Database 136 as a Data Gatherer.

Agent Functionality Description

Agent frameworks represent classes of agents. Each class of agent (framework) utilizes a specific configuration schema to perform a capability. The schema for agent configuration files ensures common APIs for a class or framework of agents. This common API provides a plug-in capability that enables each framework to scale without compounding integration efforts and other dependencies across the DKN team members.

Agent Controller—For every class of agents there is a server instance. The controller instructs and monitors agent activity. Agent Controllers can also include an instance of a Data Gatherer. Agent controllers include:
Smartphone/MID/UMPC/PDA Observer/Controller Tool
DKN Controller Workstation
Data Collection Manager

Agent Controller Manifest—This manifest represents a record of the agents employed by the Agent Controller. It is used both as a record of how agents were used as well as a plan for what agents will be used under any individual agent controller (see Data Collection Manifest).

Agent Proxy—The Agent Proxy provides a wrapper around each Agent Client forming a federation of agents that are centrally controlled by the Agent Controller.

Agent Configuration—The agent configuration is used to customize an agent instance to do the work it is intended to accomplish. The configuration is used in place of hard coded implementations where applicable. The agent configuration file is specified by the Agent Class.

Agent Instance (Client)
DKN (Filter/Analysis) Component
DKN Replay Component
Filter/Analysis Agent
Observer/Controller Tool

Ontologies and Rule-Sets—This is a repository of ontologies and rule-sets employed by the agents. The Ontologies are represented in OWL (Web Ontology Language) or RDF (Resource Description Framework) format, and the rule-sets are described in a canonical language that is independent of any RETE-based rule set.

Knowledge Repository Database—This can be one or more databases that either deliver data to the agent and/or receive generated/collected data from the agent. The connection to the databases is specified in the Agent Configuration file.

Agent frameworks include:

Data Gatherer Agent—This class of agent is integrated with the Data Collection Manager as a proxy interface over each DKN Data Gatherer.

Filter/Analysis Agent—This class of agent is integrated with the Data Gatherer Manager to automatically perform quantitative evaluations of collected data. These agents perform work such as detecting hostile interdictions over a defended asset. These agents represent a subclass of Data Gatherer Agents.

Interface Agent—This class of agent is used by Humans to observe, monitor and annotate DKN information. Interface Agents represent human-in-the-loop Data Gatherers for evaluative information specific to the goals of the application.

DKN Controller Component Agent—This class of agent is integrated with the Controller Workstation as a proxy interface over each DKN Component. These agents synchronize components for replay, report, and product generation. This synchronization includes:
Common filters applied across DKN products.
Identification of the Data Collection Session and Manifest.
Identification of the session's applicable goals.
Identification of the measures of the goals being evaluated or assessed.

Agent Operational Activity to Systems Function

Collaboration—Agent frameworks provide a common flexible means for establishing collaborative federations of individuals, teams, and software components.

Data Retrieval—Agent frameworks use a common flexible means for retrieving data from Knowledge Repository Databases.

Data Fusion—The results of collaboration are fused to/with the data queried by an agent.

Agent Data Exchange Matrix

The data exchange matrix shown in Table 1 summarizes the types of data exchanged between each class of agent and the Agent Controller which manages and instructs those agents. Specific details on this data can be found in Section.

TABLE 1
Agent Framework Data Exchange Matrix

| | Agent | |
|---|---|---|
| Agent Framework | Controller | Data Exchanged |
| Data Gatherer | Data | Synchronized time, data |
| Agent | Collection | collection state and status. |
| | Manager | |
| Filter/Analysis | Data | Synchronized time, data |
| Agent | Collection | Filter/Analysis state and |
| | Manager | status. |
| Interface Agent | TBD | Synchronized time, operational |
| | | view, and structured |
| | | observations/annotations. |
| Controller | Controller | Instructions and common rule |
| Component Agent | Workstation | sets and filters. |

The Agent Framework fulfills the needs of various federations that work toward a common purpose as defined across the Distributed Knowledge Network.

The Agent platform provides a number of capabilities, which apply to integration challenges faced today:
Intelligent Communications—Peer-2-Peer and Peer-2-Group messaging with autonomous device discovery and group processing
Interoperability Platform—a single platform for all languages (Java, .NET, IIOP, RMI, XML-RPC, SOAP, JMS, & MSMQ. C++). Bridges Android, Windows, Linux, JSE, JME CDC-CLDC, BREW, OSGi, embedded operating systems and more
Edge Processing Platform—brings server-level intelligence to SmartPhones, PDAs, sensors, cameras, etc., and enables persistent computing with/out a network connection. No single point of failure.
High Performance Platform—20-50% faster than RMI, which is the fastest “standard” distributed computing protocol

Agent Configuration Schema

Agent configurations are used to specify the implementation detail within the Agent Framework of the DKN. Each Agent Framework is focused on providing a particular class of functions to include:
Data Gatherer Agents
Interface Agents
Filter/Analysis Agents
DKN Controller Component Agents

The Agent Configuration Schema binds each framework API with the specific implementation (instance) detail for that class of agents. Each class of agent (framework) utilizes a specific schema. The Agent configuration scheme ensures APIs for a class or framework of agents is common. This common API provides a plug-in capability that enables each framework to scale without compounding integration efforts and other dependencies across the DKN team members

The platform will also be intelligent and adaptive, not just on servers, and powerful devices, but on mobile and embedded devices. It will support the notion of intelligent software components that can act autonomously on any device, written in any language, and communicate using the most effective protocol with any other device/system, or dynamically assembled groups of devices/systems.

By intelligent and adaptive, it is meant that these software components can learn and change behavior dynamically or an array of potential reason, based on what they learn, or based on changing goals or missions of the applications.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A pervasive computing platform comprising a device API Abstraction layer configured to operate as an interface between one or more applications operating on a device and an operating platform of the device, the device API abstraction layer comprising a universal set of APIs.

2. The pervasive computing platform of claim 1 wherein the universal set of APIs comprises a messaging API that provides an abstraction of a universal set of peer-to-peer messaging engines.

3. The pervasive computing platform of claim 2 wherein the universal set of APIs comprises a messaging API that provides an abstraction of a universal set of peer-to-group messaging engines.

4. The pervasive computing platform of claim 1 comprising an agent API that provides a hardware-independent agent software abstraction layer for sensors.

5. The pervasive computing platform of claim 1 comprising a service discovery by description API that provides an abstraction of a universal set of service discovery by description engines.

6. The pervasive computing platform of claim 1 comprising a service discovery by name API that provides an abstraction of a universal set of service discovery by name engines.

7. The pervasive computing platform of claim 1 comprising a universal rules API that provides an abstraction of a universal set of rules engines.

8. The pervasive computing platform of claim 1 comprising a universal database API that provides an abstraction of a universal set of database engines.

9. The pervasive computing platform of claim 1 comprising a universal Personal Information Manager API that provides an abstraction of a universal set of Personal Information Manager engines.

10. A method for providing a distributed knowledge network/intelligent sensor network comprising:
deploying a pervasive computer platform onto a plurality of devices, the pervasive computer platform comprising a device API abstraction layer comprising a universal set of APIs that enables agent software applications to execute on those devices irrespective of the parameters of the device; and
deploying one or more agent software applications to one or more of the plurality of devices;
executing the one or more agent software applications on the one or more of the plurality of devices.

11. The method of claim 10 wherein the universal set of APIs comprises a messaging API that provides an abstraction of a universal set of peer-to-peer messaging engines.

12. The method of claim 11 wherein the universal set of APIs comprises a messaging API that provides an abstraction of a universal set of peer-to-group messaging engines.

13. The method of claim 10 comprising an agent API that provides a hardware-independent agent software abstraction layer for sensors.

14. The method of claim 10 comprising a service discovery by description API that provides an abstraction of a universal set of service discovery by description engines.

15. The method of claim 10 comprising a service discovery by name API that provides an abstraction of a universal set of service discovery by name engines.

16. A device comprising at least one processor and at least one memory operatively associated with the at least one processor, the at least one memory storing a universal set of APIs that provides a hardware-independent agent software abstraction layer for one or more sensor capabilities of the device.

17. The device of claim 16 wherein the universal set of APIs comprises a messaging API that provides an abstraction of a universal set of peer-to-peer messaging engines.

18. The method of claim 17 wherein the universal set of APIs comprises a messaging API that provides an abstraction of a universal set of peer-to-group messaging engines.

19. The method of claim 16 comprising a service discovery by description API that provides an abstraction of a universal set of service discovery by description engines.

20. The method of claim 16 comprising a service discovery by name API that provides an abstraction of a universal set of service discovery by name engines.
